(19) United States
(12) Patent Application Publication
(10) Pub. No.: US 2019/0033768 A1
(43) Pub. Date: Jan. 31, 2019

(54) MEDIUM CUTTING DEVICE AND IMAGE FORMING APPARATUS

(71) Applicant: Oki Data Corporation, Tokyo (JP)

(72) Inventor: Hiroki ISHIKURA, Tokyo (JP)

(21) Appl. No.: 16/033,333

(22) Filed: Jul. 12, 2018

(30) Foreign Application Priority Data
Jul. 28, 2017 (JP) 2017-146169

(51) Int. Cl. G03G 15/00; B65H 35/00; B65H 35/06

(52) U.S. Cl. CPC G03G 15/6523; B65H 35/06; B65H 35/002

(57) ABSTRACT

A medium cutting device for cutting a continuous medium includes a sandwiching part to sandwich the medium wherein the medium is sandwiched at a sandwiching spot, a cutting blade provided with an edge at its tip for cutting the medium, and a contact part including a convex contact surface that is positioned on an opposite side from the sandwiching part with respect to the edge such that the contact surface is configured to contact the medium when the medium is pulled toward the contact part wherein a spot on the contact surface of which a tangent line passes through the sandwiching spot is defined as a first contact spot (X1). Wherein when an imaginary straight line that connects the sandwiching spot and the first contact spot is defined as a first tangent line (TL1), at least a portion of the edge is positioned on a side at which the contact part is present with respect to the first tangent line.

### TECHNICAL FIELD

The present invention relates to a medium cutting device and an image forming apparatus provided with the medium cutting device.

### BACKGROUND

An image forming apparatus has been known in which a roll sheet as a medium set in a medium supply part is sequentially fed out, and the roll sheet is cut at a predetermined length, and printing is performed on the cut sheet (for example, see Patent Document 1).

### RELATED ART

[Patent Document 1] Japanese Patent Laid-Open Publication No. 2004-330356.

In such an image forming apparatus, it is desired that the cutting operation of the medium is performed with higher accuracy.

Therefore, it is desirable to provide a medium cutting device capable of performing a cutting operation of a medium with higher accuracy, and to provide an image forming apparatus provided with the medium cutting device.

### SUMMARY

A medium cutting device, disclosed in the application, for cutting a continuous medium carried along a carrying path in a carrying direction, includes a sandwiching part that is provided on the carrying path to sandwich and carry the medium to a downstream side of the carrying direction wherein the medium is sandwiched at a sandwiching spot, a cutting blade that is provided at the downstream side of the carrying direction from the sandwiching part, and is provided with an edge at its tip for cutting the medium sandwiched by the sandwiching part, and a contact part that is provided at the downstream side of the carrying direction from the cutting blade, and includes a convex contact surface that is positioned on an opposite side from the sandwiching part with respect to the edge such that the carrying path runs between the contact surface and the edge, and the contact surface is configured to contact the medium when the medium is pulled toward the contact part wherein a spot on the contact surface of which a tangent line passes through the sandwiching spot is defined as a first contact spot (X1). Wherein when an imaginary straight line that connects the sandwiching spot and the first contact spot is defined as a first tangent line (TL1), at least a portion of the edge is positioned on a side at which the contact part is present with respect to the first tangent line.

Also, an image forming apparatus that is one embodiment disclosed in the application is provided with the medium cutting device discussed above.

In a medium cutting device and an image forming apparatus as an embodiment of the present invention, a cutting blade including an edge is provided between a sandwiching part that sandwiches a medium and a contact part that includes a contact surface. Therefore, by pulling the medium to a downstream side, a stress is effectively concentrated and applied to a portion of the medium that is in contact with the first contact surface.

According to the medium cutting device and the image forming apparatus as an embodiment of the present disclosure, a cutting operation of the medium can be performed with higher accuracy. The effects of the present invention are not limited to this, and may include any of the effects described below.

### BRIEF DESCRIPTION OF THE DRAWINGS

FIG. 1A is a perspective view illustrating an example of an overall configuration of an image forming apparatus according to an embodiment of the present invention.

FIG. 1B is another perspective view illustrating the example of the overall configuration of the image forming apparatus illustrated in FIG. 1A.

FIG. 2 is a schematic view illustrating an internal structure of the image forming apparatus illustrated in FIG. 1A.

FIG. 3 is an enlarged schematic view illustrating a portion of the internal structure of the image forming apparatus illustrated in FIG. 2.

FIG. 4 is a perspective view illustrating a cutting blade illustrated in FIG. 3.

FIG. 5 is a rear view illustrating an appearance of the cutting blade illustrated in FIG. 3.

FIG. 6 is a block diagram schematically illustrating an example of the internal configuration of the image forming apparatus illustrated in FIG. 1A.

FIG. 7A is a first schematic view illustrating how a medium is cut with an edge in the image forming apparatus illustrated in FIG. 1A.

FIG. 7B is a second schematic view illustrating how a medium is cut with the edge in the image forming apparatus illustrated in FIG. 1A.

FIG. 8A is a third schematic view illustrating how a medium is cut with the edge in the image forming apparatus illustrated in FIG. 1A.

FIG. 8B is a fourth schematic view illustrating how a medium is cut with the edge in the image forming apparatus illustrated in FIG. 1A.

FIG. 9 is a rear view illustrating an appearance of a cutting blade as a first modified embodiment when the cutting blade is viewed from a back side.

FIG. 10 is a rear view illustrating an appearance of a cutting blade as a second modified embodiment when the cutting blade is viewed from a back side.

FIG. 11 is a perspective view illustrating the cutting blade as the second modified embodiment.

### DETAILED DESCRIPTION OF THE PREFERRED EMBODIMENTS

In the following, an embodiment of the present invention is described with reference to the drawings. The following description is a specific example of the present invention. The present invention is not limited to the following embodiments. Further, the present invention is not limited to arrangements, dimensions, dimension ratios and the like of configuration elements illustrated in the drawings. The description will be presented in the following order:
1. Embodiment

An image forming apparatus provided with a medium cutting device.
2. Modified Embodiment
2.1 First Modified Embodiment
2.2 Second Modified Embodiment
3. Experimental Embodiment
4. Other Modified Embodiments

### 1. Embodiment

### [1.1 Schematic Configuration of Image Forming Apparatus 1]

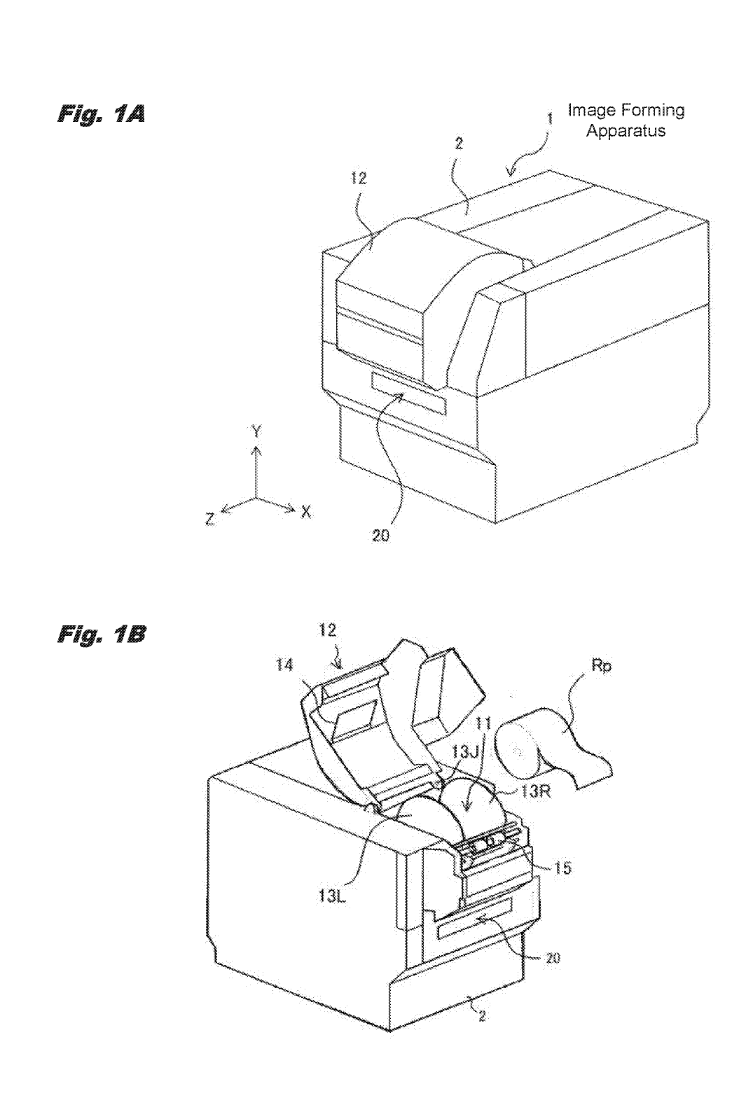

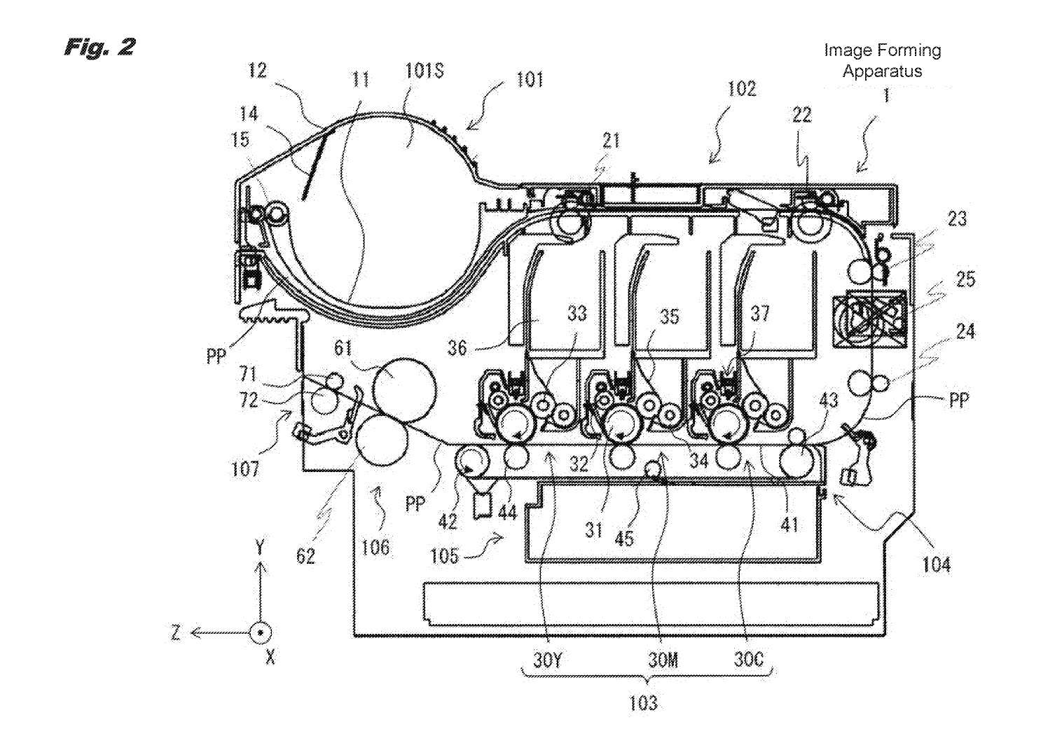

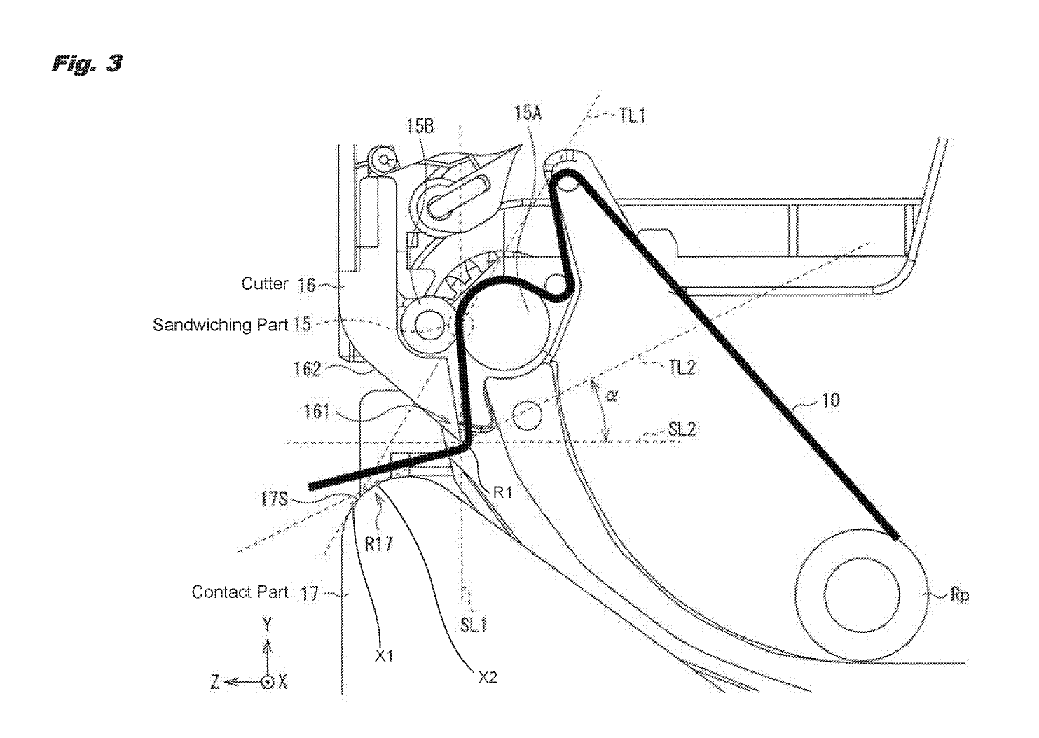

FIG. 1A is a perspective view illustrating an external appearance of an image forming apparatus 1 according to an embodiment of the present invention. FIG. 1B is a perspective view illustrating the image forming apparatus 1 illustrated in FIG. 1A in such a manner that a portion of an internal configuration thereof is visible. FIG. 2 is a schematic view illustrating an example of an overall internal configuration of the image forming apparatus 1 illustrated in FIG. 1A. FIG. 3 is an enlarged schematic view illustrating a portion of an internal structure of the image forming apparatus 1.

The image forming apparatus 1 includes, for example, inside a case 2, for example, a medium supply part 101, a medium carrying part 102, an image forming part 103, a transfer device 104, a developer collection device 105, a fuser device 106, and a locking part 107. A carrying path PP is further formed in the image forming apparatus 1. The carrying path PP is a path through which a medium 10 passes and which starts from the medium supply part 101, sequentially passes through the medium carrying part 102, the image forming part 103 and the transfer device 104, the developer collection device 105, the fuser device 106, and the locking part 107, and finally reaches outside of the case 2. In the present specification, a direction approaching the medium supply part 101 from an arbitrary position on the carrying path PP, or a position that is closer to the medium supply part 101 than the arbitrary position is (a position between the arbitrary position and the medium supply part 101) is referred to as upstream. On the other hand, a direction away from the medium supply part 101 from an arbitrary position on the carrying path PP, or a position that is closer to the locking part 107 than the arbitrary position is (a position between the arbitrary position and the locking part 107) is referred to as downstream.

(Medium Supply Part 101)

The medium supply part 101 includes a holding part 11, a cover 12, a pair of side guides 13L, 13R, a guide 14 erected on an inner surface of the cover 12, a sandwiching part 15 (a carrying roller 15A and a pinch roller 15B), a cutter 16 and a contact part 17 (FIG. 3). The sandwiching part 15, the cutter 16 and the contact part 17 correspond to a specific example of “a medium cutting device” of the present invention.

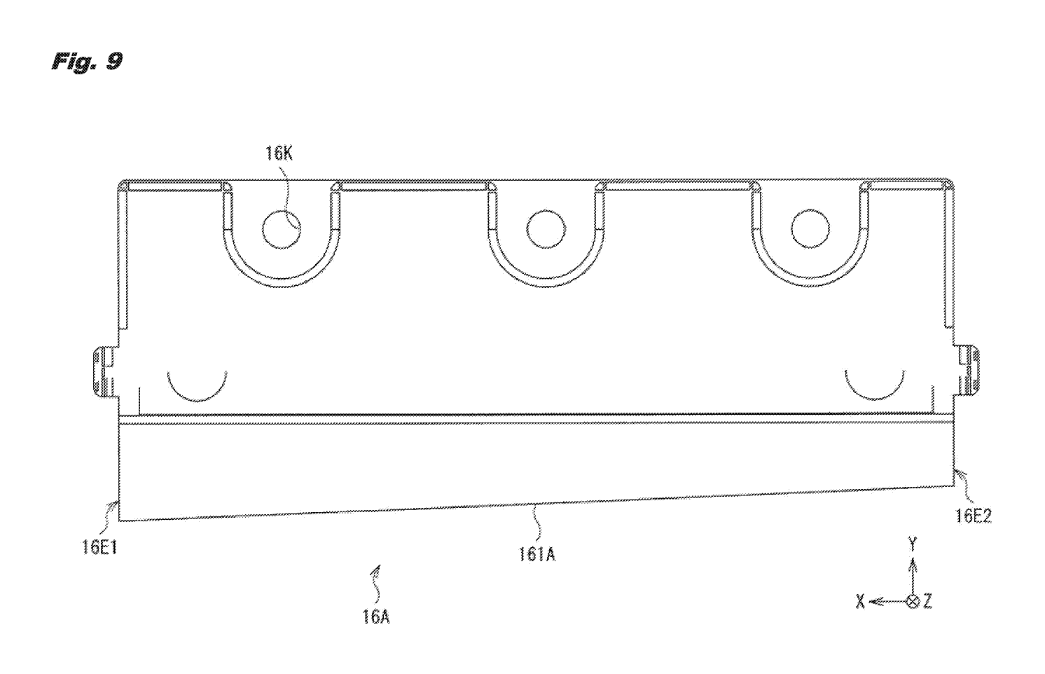

The holding part 11 is a part that holds a roll Rp as a supply source of the medium 10 on which an image is formed, and, together with a cover 12, forms a space 101S accommodating the roll Rp. The cover 12 is a protective member that is provided so as to cover the roll Rp accommodated in the space 101S. The roll Rp is formed by winding a continuous sheet. As the medium 10, it is also possible to use a medium formed by intermittently providing multiple stickers on a continuous sheet. Further, a material of the continuous sheet is not limited to paper, but may be, for example, a transparent resin or the like. The pair of side guides 13L, 13R is a member for guiding lateral sides of the roll Rp accommodated in the space 101S. The guide 14 is a member that guides the medium 10 fed out from the roll Rp so that the medium 10 stably travels toward the carrying path PP. The carrying roller 15A and the pinch roller 15B are arranged opposing each other with the medium 10 sandwiched therebetween, and form the sandwiching part 15. The sandwiching part 15 is a specific example corresponding to “a sandwiching part” of the present invention, and the carrying roller 15A and pinch roller 15B are a specific example corresponding to “a pair of rotating bodies” of the present invention. The carrying roller 15A, in cooperation with the pinch roller 15B, functions to feed out the medium 10 from the roll Rp and sequentially carry the medium 10 toward the medium carrying part 102. The carrying roller 15A is rotatably supported directly or indirectly by the case 2, whereas the pinch roller 15B is rotatably supported by the cover 12. The medium supply part 101 further includes a sheet feeding motor 811 (described in FIG. 9 below). The carrying roller 15A is rotationally driven by the sheet feeding motor 811.

The cutter 16 is a medium cutting member that, for example, is detachably provided with respect to the cover 12, and includes an edge 161 that, for example, cuts the medium 10, which is carried (fed out) from upstream to downstream along the carrying path PP, along a width direction (X axis direction) orthogonal to a carrying direction. The cutter 16 is formed of, for example, a resin, and cuts, with the edge 161, the medium 10, which is drawn from the roll Rp set in the space 101S, along the X axis direction, and forms a leading edge surface 10S extending along the X axis direction in the medium 10. The edge 161 has, for example, a curvature R1. Curvature=1/radius. The radius is a half of diameter of a circle. The radius may be determined as a specification that most properly represents a curved shape. Here, the cutter 16 is a specific example corresponding to “a cutting blade” of the present invention; the edge 161 is a specific example corresponding to “an edge” of the present invention; and the curvature R1 is “a first curvature” of the present invention. Details of the cutter 16 will be described later.

The contact part 17 is fixed, for example, to the case 2, and may function as a support part supporting the medium 10 when the medium 10 is cut at the edge 161. The contact part 17 is positioned on an opposite side with respect to the sandwiching part 15 as viewed from the edge 161, and includes a convex contact surface 17S which can be in contact with the medium 10. The contact surface 17S has, for example, a curvature R17 smaller than the curvature R1. As least a portion of the edge 161 is preferably positioned on the contact part 17 side of a tangent TL1 of the contact surface 17S passing through the sandwiching part 15. This is because the medium 10 can be smoothly cut. Further, the contact surface 17S is desirably formed of only a continuous surface that does not include a bent portion. This is to avoid that a localized stress is applied to the medium 10 in contact with the contact surface 17S. The contact surface 17S is “a contact surface” of the present invention, and the curvature R17 is “a second curvature” of the present invention. Further, the tangent TL1 is a specific example corresponding to “a first tangent” of the present invention.

(Medium Carrying Part 102)

The medium carrying part 102 includes carrying roller pairs 21-24 that are arranged in this order from upstream to downstream along the carrying path PP, a cutter 25. The carrying roller pairs 21-24 carry the medium fed out from the medium supply part 101 toward the image forming part 103 and the transfer device 104 on a downstream side. The cutter 25 is arranged between the carrying roller pair 23 and the carrying roller pair 24, and cuts the medium carried over the carrying path PP at a predetermined length. The medium carrying part 102 further includes a carrying motor 812 (described in FIG. 9 below). The carrying roller pairs 21-24 and the cutter 25 are driven by the carrying motor 812.

(Image Forming Part 103)

The image forming part 103 is positioned on a downstream side of the medium carrying part 102, and includes image forming units 30Y, 30M, 30C that are arranged in this order from an upstream side along the carrying path PP. The image forming units 30Y-30C each includes a photosensitive drum 31, a charging roller 32, a development roller 33, a supply roller 34, a development blade 35, a developer container 36, and an LED (Light Emitting Diode) head 37. The image forming units 30Y, 30M, 30C respectively use developers (toners) of mutually different colors to form developer images (toner images) of the respective colors on surfaces of their photosensitive drums 31. Specifically, for example, the image forming unit 30C uses a cyan developer to form a cyan developer image; the image forming unit 30M uses a magenta developer to form a magenta developer image; and the image forming unit 30Y uses a yellow developer to form a yellow developer image. The image forming part 103 further includes a drive motor DM (described in FIG. 9 below). The photosensitive drums 31 and the like are rotationally driven by the drive motor DM.

The photosensitive drums 31 are each a column-shaped member that carries an electrostatic latent image a surface (surface-layer portion) thereof, and are each structured using a photosensitive body (for example, an organic photosensitive body). The photosensitive drums 31 rotate at a predetermined circumferential speed in a predetermined direction (in this example, rotate clockwise as indicated by an arrow in FIG. 2).

The charging rollers 32 are members (charging members) that respectively charge the surfaces (surface-layer portions) of the photosensitive drums 31, and are respectively arranged so as to be in contact with the surfaces (circumferential surfaces) of the photosensitive drums 31. In this example, the charging rollers 32 rotate counterclockwise.

The development rollers 33 are each a member that carries on a surface thereof a developer for developing an electrostatic latent image, and are respectively arranged so as to be in contact with the surfaces (circumferential surfaces) of the photosensitive drums 31. In this example, the development rollers 33 rotate counterclockwise.

The supply rollers 34 are members (supply members) for respectively supplying developers to the development rollers 33, and are respectively arranged so as to be in contact with surfaces (circumferential surfaces) of the development rollers 33. In this example, the supply rollers 34 rotate counterclockwise (in the same direction as the development rollers 33).

The development blades 35 are developer regulating members that respectively form layers of developers (developer layers) on the surfaces of the rotating development rollers 33, and respectively regulate (control and adjust) thicknesses of the developer layers. The development blades 35 are, for example, plate-like elastic members (plate springs) that are each formed of stainless steel or the like, and front end parts of the plate-like elastic members are respectively arranged near the surfaces of the development rollers 33.

The developer containers 36 are each a container accommodating a developer of a predetermined color therein, and, for example, a developer discharge port is provided at a lower portion of each of the developer containers 36.

The LED heads 37 respectively expose the surfaces of the opposing photosensitive drums 31, and respectively form electrostatic latent images on the surfaces of the photosensitive drums 31.

(Transfer Device 104)

The transfer device 104 is arranged below the image forming part 103 so as to oppose the image forming part 103 across the carrying path PP. As illustrated in FIG. 2, the transfer device 104 includes a carrying belt 41, a drive roller 42 that drives the carrying belt 41, a driven roller 43, transfer rollers 44, and a contact roller 45. The transfer rollers 44 are rotationally driven by the drive motor DM.

The carrying belt 41 is a belt for carrying the medium downstream along the carrying path PP. Specifically, the carrying belt 41 is, for example, an endless elastic belt formed of a resin material such as polyimide resin, and is stretched by the drive roller 42, the driven roller 43, the transfer rollers 44 and the contact roller 45, and cyclically rotates counterclockwise in FIG. 2. The driven roller 43 rotates following the rotation of the drive roller 42 and the carrying belt 41. The transfer rollers 44 are members for electrostatically transferring developer images formed in the image forming part 103 onto the medium, and are arranged so as to respectively oppose the photosensitive drums 31 across the carrying belt 41. The contact roller 45 is arranged so as to oppose a cleaning blade (not illustrated in the drawings) of the developer collection device 105 across the carrying belt 41, and presses the carrying belt 41 against the cleaning blade.

(Developer Collection Device 105)

The developer collection device 105 is arranged below the transfer device 104 and collects unnecessary developer attached to the carrying belt 41.

(Fuser Device 106)

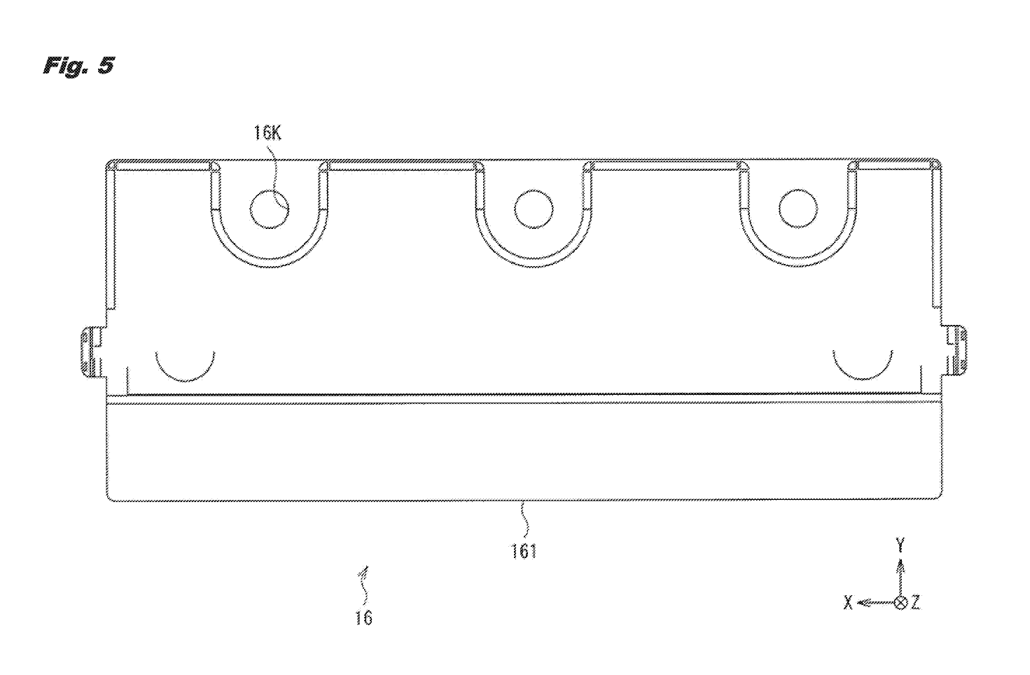

The fuser device 106 is positioned on a downstream side of the image forming part 103 and the transfer device 104, and functions so as to apply heat and pressure to a developer image transferred onto the medium carried from the transfer device 104, thereby fusing the developer image onto the recording medium. The fuser device 106 includes a fuser roller 61 with a built-in heater 791 (described in FIG. 5 below), and a pressure application roller 62 arranged such that the medium traveling on the carrying path PP is sandwiched between the fuser roller 61 and the pressure application roller 62. The fuser device 106 further includes a thermistor 792 (described in FIG. 9 below) that performs its own temperature detection. The fuser roller 61 is, for example, rotationally driven by the drive motor DM.

(Locking Part 107)

The locking part 107 includes, for example, ejection rollers 71, 72 that are arranged opposing each other. The ejection rollers 71, 72 are, for example, rotationally driven by the drive motor DM, and eject the medium ejected from the fuser device 106 to the outside.

[1.2 Configuration of Cutter 16]

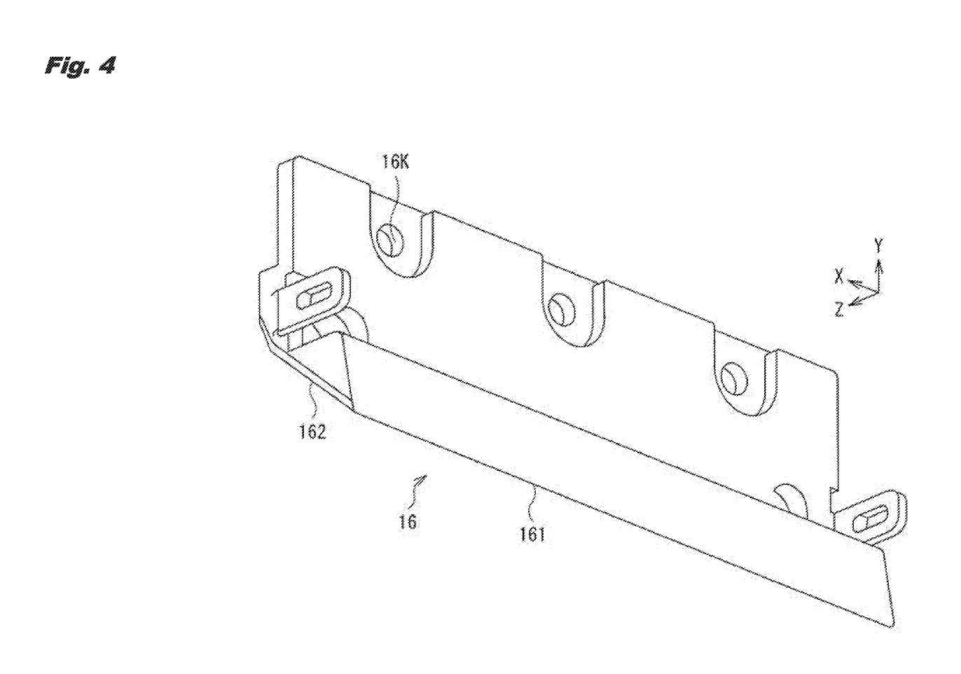

Next, a detailed configuration of the cutter 16 is described with reference to FIGS. 4 and 5. FIG. 4 is a perspective view illustrating the cutter 16 illustrated in FIG. 3. FIG. 5 is a rear view illustrating an appearance of the cutter 16 illustrated in FIG. 3 when the cutter 16 is viewed from a back side (from the inside of the image forming apparatus 1). The cutter 16 is provided with an opening 16K at a portion distant from the edge 161, and can be fixed to the cover 12 by screwing or the like.

As illustrated in FIGS. 4 and 5, the edge 161 of the cutter 16 extends, for example, linearly along the X axis direction.

The cutter 16 has a convex side surface 162 having a curvature R162 smaller than the curvature R1. The side surface 162 extends away from both the edge 161 and the contact part 17 starting from the edge 161 and opposes the contact surface 17S. The side surface 162 is a surface that has a possibility of being in contact with the medium 10 in a case where the contact surface 17S is not in contact with the medium 10 when the medium 10 is cut at the edge 161. When the side surface 162 is in contact with the medium 10, the side surface 162 functions as a support part supporting the medium 10. The side surface 162 is desirably formed of only a continuous surface that does not include a bent portion. This is to avoid that a localized stress is applied to the medium 10 in contact with the side surface 162. The side surface 162 is a specific example corresponding to “a side surface” of the present invention.

As illustrated in FIG. 3, the contact surface 17S is positioned on an opposite side with respect to the sandwiching part 15 across a second straight line SL2 passing through the edge 161.

The second straight line SL2 is orthogonal to a first straight line SL1 passing through the sandwiching part 15 and the edge 161. Here, an angle a formed by a second tangent TL2 of the contact surface 17S passing through the edge with respect to the second straight line SL2 is preferably 0° or more and 55° or less. This is because a cutting operation of the medium 10 at the edge 161 by a user to be described later can be easily and accurately performed.

[1.3 Circuit Configuration of Image Forming Apparatus 1]

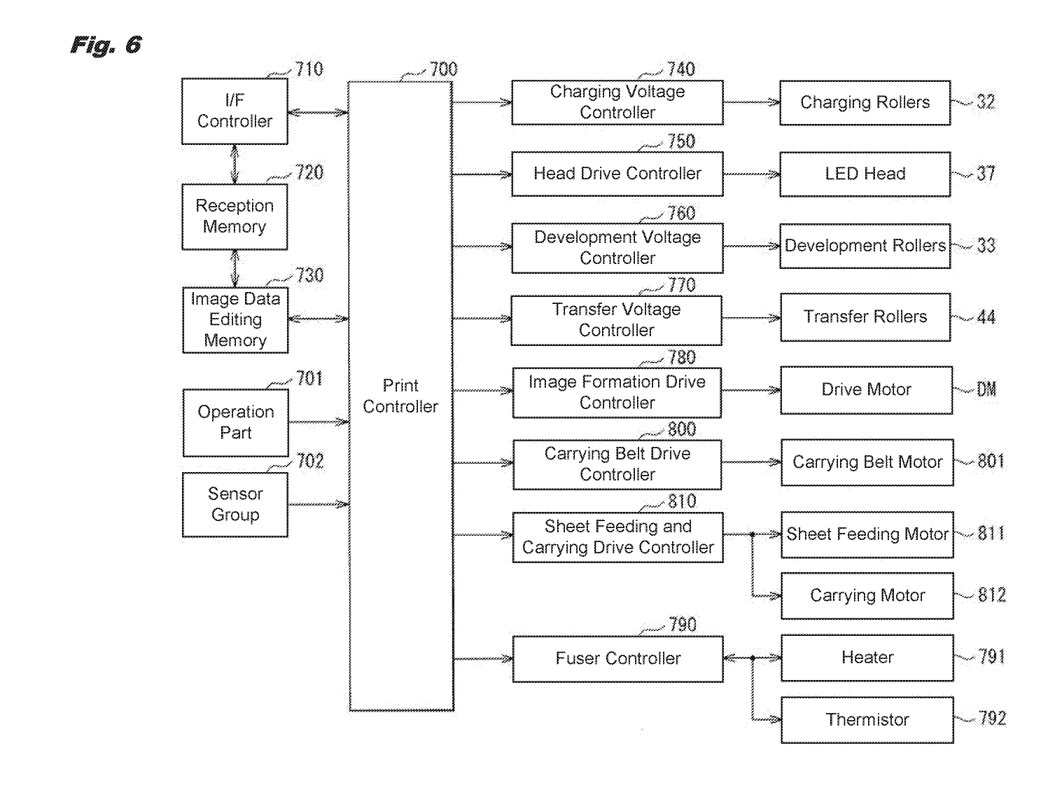

FIG. 6 illustrates a block diagram schematically illustrating an internal configuration of the image forming apparatus 1. As illustrated in FIG. 6, the image forming apparatus 1 includes a print controller 700, an I/F controller 710, a reception memory 720, an image data editing memory 730, an operation part 701 and a sensor group 702. The image forming apparatus 1 further includes a charging voltage controller 740, a head drive controller 750, a development voltage controller 760, a transfer voltage controller 770, an image formation drive controller 780, a fuser controller 790, a carrying belt drive controller 800, and a sheet feeding and carrying drive controller 810, which each receive a command from the print controller 700.

The print controller 700 is configured by a microprocessor, a ROM, a RAM, an input and output port, and the like, and controls the entire processing operation of the image forming apparatus 1 by executing, for example, a predetermined program. Specifically, the print controller 700 receives print data and a control command from the I/F controller 710, and performs a print operation by integrally controlling the charging voltage controller 740, the head drive controller 750, the development voltage controller 760, the transfer voltage controller 770, the image formation drive controller 780, the fuser controller 790, the carrying belt drive controller 800 and the sheet feeding and carrying drive controller 810.

The I/F controller 710 receives the print data and the control command from an external device such as a personal computer (PC), or transmits a signal related to a state of the image forming apparatus 1.

The reception memory 720 temporarily stores the print data from the external device such as a PC via the I/F controller 710.

The image data editing memory 730 receives the print data stored in the reception memory 720 and stores image data obtained by editing the print data.

The operation part 701, for example, has an LED lamp for displaying information about the state of the image forming apparatus 1 and the like, and has an input part (a button or a touch panel) for allowing a user to give an instruction to the image forming apparatus.

The sensor group 702 includes various sensors for monitoring an operation state of the image forming apparatus 1, for example, a position sensor that detects a position of the medium, a temperature sensor that detects a temperature in the image forming apparatus 1, a print density sensor, and the like.

The charging voltage controller 740, according to an instruction from the print controller 700, performs control so as to apply charging voltages to the charging rollers 32 and charge the surfaces of the photosensitive drums 31.

The head drive controller 750, according to the image data stored in the image data editing memory 730, performs control of an exposure operation by the LED heads 37.

The development voltage controller 760, based on an instruction from the print controller 700, performs control so as to apply development voltages to the development rollers 33, and develop the electrostatic latent images formed on the surfaces of the photosensitive drums 31 with toners.

The transfer voltage controller 770, based on an instruction from the print controller 700, performs control so as to apply transfer voltages to the transfer rollers 44, and transfer the toner images onto the medium.

The image formation drive controller 780, based on an instruction from the print controller 700, performs drive control of the drive motor DM. The drive motor DM performs rotation driving of the photosensitive drums 31 and the like.

The fuser controller 790, based on an instruction from the print controller 700, controls a fuse operation of the fuser device 106. Specifically, the fuser controller 790 performs control of an applied voltage to the heater 791 (FIG. 9) built in the fuser roller 61. The fuser controller 790, based on a temperature of the fuser device 106 measured by the thermistor 792, performs On-Off control of an applied voltage to the heater 791.

The carrying belt drive controller 800, based on an instruction from the print controller 700, performs operation control of a carrying belt motor 801 provided in the image forming apparatus 1. The carrying belt motor 801 performs driving of the carrying belt 41.

The sheet feeding and carrying drive controller 810, based on an instruction from the print controller 700, performs operation control of the sheet feeding motor 811 and the carrying motor 812, which are provided in the image forming apparatus 1.

[1.4 Operation Effects]

### (A. Basic Operation)

In the image forming apparatus 1, a developer image is transferred to the medium as follows.

Specifically, first, based on the control of the sheet feeding and carrying drive controller 810, the sheet feeding motor 811 performs driving, and the carrying roller 15A rotates. As a result, the medium 10 is picked up from the roll Rp accommodated in the space 101S in the medium supply part 101 and is fed out by the carrying roller 15A in a direction toward the medium carrying part 102 on a downstream side. Next, the medium 10 fed out from the roll Rp is carried toward the image forming part 103 and the transfer device 104 on a downstream side while a skew is corrected by the medium carrying part 102. At the medium carrying part 102, the medium 10 is cut at a predetermined length by the cutter 25. In this case, based on the control of the sheet feeding and carrying drive controller 810, a driving force of the sheet feeding motor 811 is transmitted to the cutter 25.

At the image forming part 103 and the transfer device 104, a toner image is transferred onto the medium 10 as follows. First, print image data and a print command are input to the print controller 700 from an external device such as a PC via the I/F controller 710 to the image forming apparatus 1 in an activated state. In response to the print command, the print controller 700, in cooperation with the image formation drive controller 780 or the like, starts a print operation of the print image data.

The image formation drive controller 780 drives the drive motor DM to rotate the photosensitive drums 31 in a predetermined direction at a constant speed. When the photosensitive drums 31 rotate, motive forces of the photosensitive drums 31 are respectively transmitted to the supply rollers 34, the development rollers 33 and the charging rollers 32 via drive transmission parts such as gear trains. As a result, the supply rollers 34, the development rollers 33 and the charging rollers 32 each rotate in a predetermined direction.

On the other hand, based on a command from the print controller 700, the charging voltage controller 740 respectively applies predetermined voltages to the charging rollers 32 to uniformly charge the surfaces of the photosensitive drums 31.

Next, the head drive controller 750 activates the LED heads 37 to irradiate the photosensitive drums 31 with light corresponding to a print image based on an image signal to respectively form electrostatic latent images on the surfaces of the photosensitive drums 31. Further, developers are respectively supplied from the developer containers 36 to the supply rollers 34. The developers are respectively carried by the supply rollers 34 and are respectively moved to vicinities of the development rollers 33 with the rotations of the supply rollers 34. Therefore, the developers are respectively, for example, negatively charged due to potential differences between potentials of the development rollers 33 and potentials of the supply rollers 34, and are respectively supplied to the development rollers 33. The developers that are respectively supplied to the development rollers 33 respectively form developer layers which are respectively regulated by the development blades 35 to each have a predetermined thickness.

Further, in accordance with the electrostatic latent images that are respectively formed on the surfaces of the photosensitive drums 31, the developer layers on the development rollers 33 are developed, and developer images are respectively formed on the photosensitive drums 31. The developer images are transferred to the medium 10 on the carrying path PP by electric fields between the photosensitive drums 31 and the transfer rollers 44, the transfer rollers 44 being respectively arranged opposing the photosensitive drums 31 and predetermined voltages being respectively applied to the transfer rollers 44 by the transfer voltage controller 770.

Thereafter, at the fuser device 106, heat and pressure are applied to the developer images transferred onto the medium 10, and the developer images are fused on the medium 10. Thereafter, the medium 10 onto which the developer images have been fused is ejected to the outside by the locking part 107.

There may be a case where a small amount of developer not transferred to the medium 10 remains on the photosensitive drums 31. In this case, the remaining developer may adhere to the carrying belt 41. Therefore, in the image forming apparatus 1, the developer collection device 105 collects the developer adhering to the carrying belt 41 as waste toner.

(B. Cueing Operation of Medium 10 from Roll Rp)

As a process of a stage before a driving operation of the image forming apparatus 1 is performed, the roll Rp is accommodated in the space 101S of the medium supply part 101 and the leading edge surface 10S (to be described later) extending along the X axis direction is formed. Specifically, a user first opens the cover 12 and places the roll Rp in a portion of the case 2 where the space 1015 is formed. Next, the user pulls out an outermost peripheral end portion of the roll Rp to the outside of the case 2, and then closes the cover 12. By closing the cover 12, the medium 10 pulled out by the user is sandwiched between the carrying roller 15A and the pinch roller 15B.

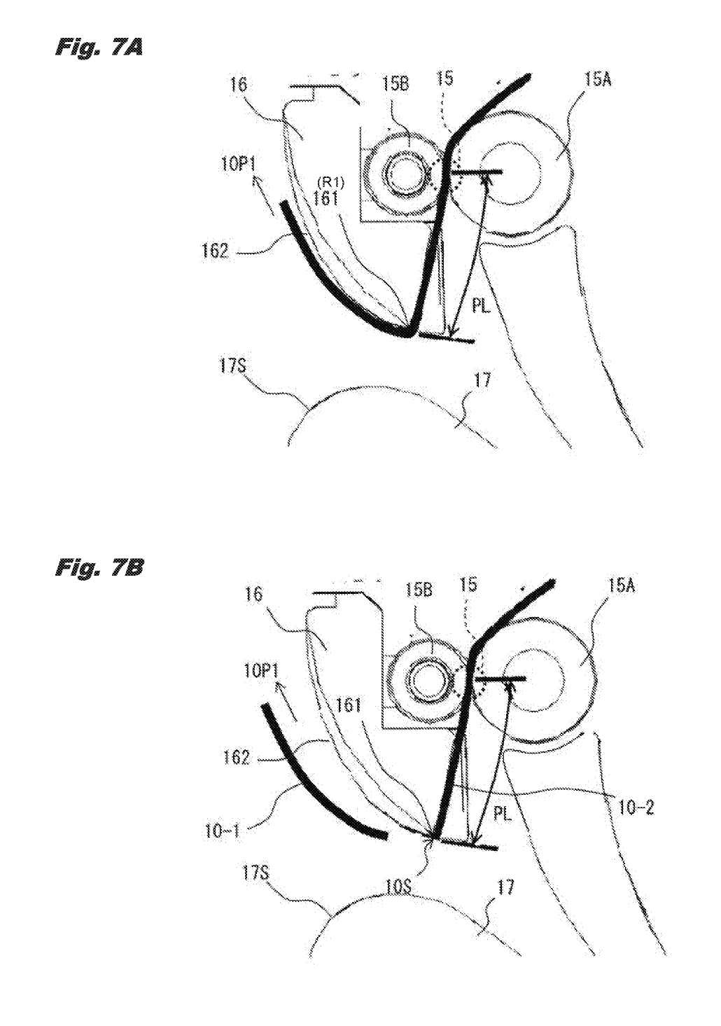

Thereafter, for example, as illustrated in FIG. 7A, the user pulls with his/her own hand the end portion of the pulled out medium 10 obliquely upward (in an arrow 10P1 direction), thereby applying a stress to the medium 10. As a result of this operation, a shear stress effectively concentrates on a portion of the medium 10 that is in contact with the edge 161, and, for example, as illustrated in FIG. 7B, the medium 10 breaks at a place (stress concentration place) of the medium 10 where the shear stress concentrates. Here, FIGS. 7A and 7B are schematic diagrams illustrating how the medium 10 is cut with the edge 161. FIG. 7A illustrates a state immediately before the medium 10 sandwiched by the sandwiching part 15 is cut by the edge 161. As illustrated in FIG. 7A, when the user pulls the end portion of the medium 10 sandwiched by the sandwiching part 15 obliquely upward, basically, the medium 10 is in contact with the edge 161 of the cutter 16. Therefore, the portion of the medium 10 that is in contact with the edge 161 is the stress concentration place. Or, it is also possible that the medium 10 sandwiched by the sandwiching part 15 is in contact with the edge 161 and is also in contact with the side surface 162. In that case, the medium 10 is supported at two places, the sandwiching part 15 and the side surface 162. Also in this case, the portion of the medium 10 that is in contact with the edge 161 positioned between the sandwiching part 15 and the side surface 162 is a stress concentration place. As described above, this is because the side surface 162 has the curvature R162 which is smaller than the curvature R1 of the edge 161. As a result, as illustrated in FIG. 7B, the medium 10 breaks at the stress concentration site. A front end portion 10-1 of the medium 10 is detached, and a leading edge surface 10S cut with high accuracy is formed in a remaining portion 10-2 of the medium 10. FIG. 7B illustrates a state immediately after the medium 10 is cut by the edge 161.

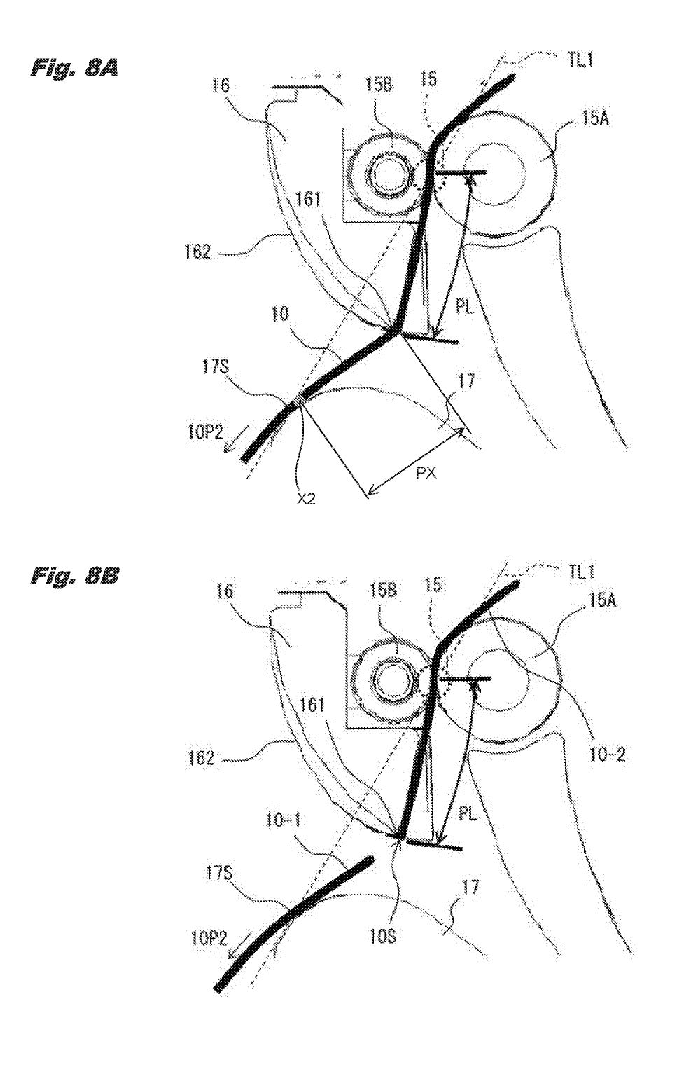

On the other hand, in the image forming apparatus 1 of the present embodiment, for example, as illustrated in FIG. 8A, even when the user pulls with his/her own hand the end portion of the pulled out medium 10 obliquely downward (in an arrow 10P2 direction), the medium 10 can be accurately cut. Specifically, when the user pulls the end portion of the medium 10 obliquely downward, the medium 10 is brought into contact with the contact surface 17S of the contact part 17. As a result, the medium 10 is supported at two places, the sandwiching part 15 and the contact surface 17S. The portion of the medium 10 that is in contact with the edge 161 positioned between the sandwiching part 15 and the contact surface 17S is a stress concentration place, and, as illustrated in FIG. 8B, the medium 10 breaks at the stress concentration place. As described above, this is because the contact surface 17S has the curvature R17 which is smaller than the curvature R1 of the edge 161. As a result, a front end portion of the medium 10 is detached, and a leading edge surface 10S cut with high accuracy is formed in a remaining portion 10-2 of the medium 10. FIGS. 8A and 8B each illustrate a state when the user pulls with his/her own hand the end portion of the medium 10 obliquely downward. In particular, FIG. 8A illustrates a state immediately before the medium 10 is cut by the edge 161, and FIG. 8B illustrates a state immediately after the medium 10 is cut by the edge 161. Also in the cases illustrated by FIGS. 8A and 8B, the leading edge surface 10S is substantially parallel to the X axis direction.

In FIGS. 8A and 8B, only a top portion of the contact part is illustrated in the drawings. The lower portion may be positioned left with respect to the first tangent line TL1, which is at an opposite side from the edge. Not to mention, the entire portion of the contact part including the lower portion may be positioned right with respect to the first tangent line, which is at the same side as the edge.

Here, there is substantially no difference in a path length PL of the carrying path PP from the sandwiching part 15 to the edge 161 between the case of pulling the medium 10 obliquely upward (in the arrow 10P1 direction) and the case of pulling the medium 10 obliquely downward (in the arrow 10P2 direction).

The remaining portion 10-2 of the medium 10 in which the leading edge surface 10S is formed is carried from the medium supply part 101 to the medium carrying part 102 along the carrying path PP by the rotation operation of the carrying roller 15A.

(C. Effects)

In this way, in the present embodiment, the edge 161 is provided between the sandwiching part 15 that sandwiches the medium 10 and the contact part 17 that includes the contact surface 17S positioned on a downstream side of the sandwiching part 15. Therefore, by pulling the medium 10 toward downstream, a portion of the medium 10 is supported at two places, the sandwiching part 15 and the contact surface 17 S, and a stress is effectively concentrated and applied to a portion of the medium 10 that is in contact with the edge 161. Therefore, the cutting operation of the medium 10 can be performed with higher accuracy, and a highly accurate leading edge surface 10S can be obtained.

Further, in the present embodiment, even when the user pulls the medium 10 either obliquely upward (in the arrow 10P1 direction) or obliquely downward (in the arrow 10P2 direction), the medium 10 breaks in a vicinity of the edge 161, and, as a result, the leading edge surface 10S is formed in the medium 10. Therefore, even when the user pulls with his/her own hand the end portion of the medium 10 obliquely upward or obliquely downward, the same leading edge surface 10S can be stably obtained. Therefore, it is a user-friendly medium cutting device.

Further, in the present embodiment, the cutting operation of the medium 10 is executed due to mechanical structures of the cutter 16 and in the vicinity of the cutter 16, and thus, an additional actuators or an additional control signal is not required. Therefore, no complication in mechanism is required.

### 2. Modified Embodiments

### 2.1 First Modified Embodiment

Next, with reference to FIG. 9, a cutter 16A as a first modified embodiment of the present embodiment is described. FIG. 9 is a rear view illustrating an appearance of the cutter 16A when the cutter 16A is viewed from a back side.

In the above embodiment, the case where the cutter 16 includes the edge 161 extending along the X axis direction is described. In contrast, the cutter 16A of the present modified embodiment includes an edge 161A that is inclined with respect to the X axis direction. The cutter 16A includes a first end portion 16E1 and a second end portion 16E2 positioned on an opposite side with respect to the first end portion in the X axis direction. The edge 161A is inclined with respect to the X axis direction in such a manner that substantially the same slope is maintained from the first end portion 16E1 to the second end portion 16E2.

According to the cutter 16A, when the medium 10 comes into contact with the edge 161A, for example, a stress concentrates on a portion of the medium 10 that is in contact with the first end portion 16E1, and thus, the medium 10 is cut in such a manner that a crack progresses from the first end portion 16E1 to the second end portion 16E2. Therefore, as compared to the cutter 16, a sharper leading edge surface 10S is more likely to be obtained.

### 2.2 Second Modified Embodiment

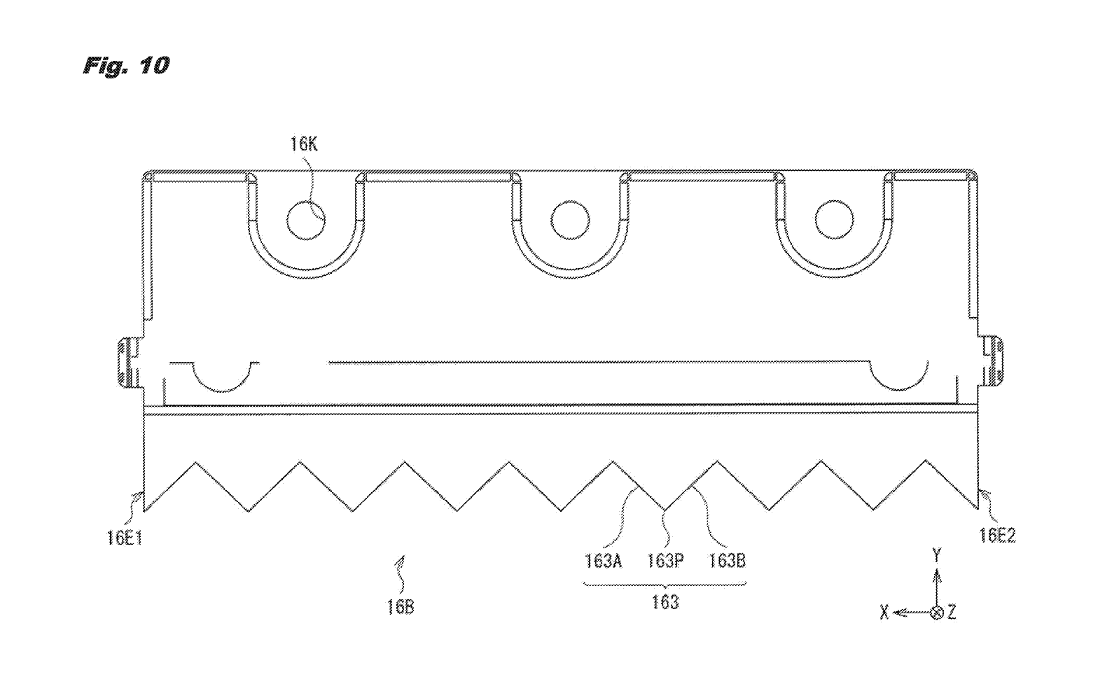

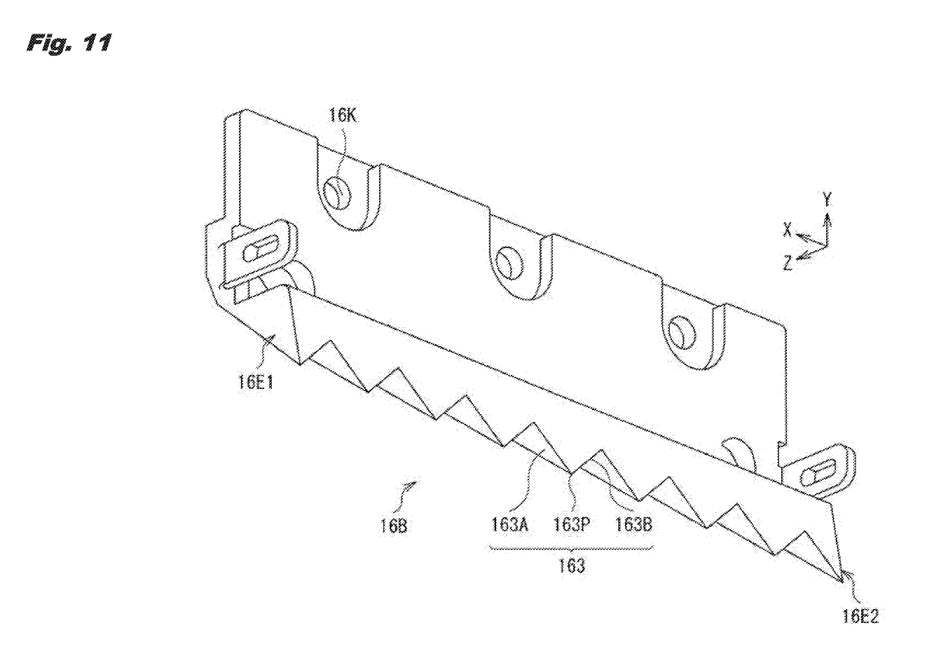

Next, with reference to FIGS. 10 and 11, a cutter 16B as a second modified embodiment of the present embodiment is described. FIG. 10 is a rear view of the cutter 16B when the cutter 16B is viewed from a back side. FIG. 11 is perspective view illustrating the cutter 16.

The cutter 16B of the present modified embodiment has an edge 163 that includes multiple apexes 163P and multiple first inclined portions 163A and multiple second inclined portions 163B, the multiple first inclined portions 163A and the multiple second inclined portions 163B respectively extending from the multiple apexes 163P as starting points. The cutter 16B includes a first end portion 16E1 and a second end portion 16E2 positioned on the opposite side with respect to the first end portion in the X axis direction. In the edge 163, the first inclined portions 163A and the second inclined portions 163B are alternately arranged in the X axis direction. The first inclined portions 163A are inclined so as to be more distant from the carrying path PP (extend toward a +Y direction) as the first inclined portions 163A respectively extend from the apexes 163P toward the first end portion 16E1. The second inclined portion 163B are inclined so as to be more distant from the carrying path PP (extend toward the +Y direction) as the second inclined portion 163B respectively extend from the apexes 163P toward the second end portion 16E2.

According to the cutter 16B, the edge 163 includes the multiple apexes 163P. Therefore, when the medium 10 is brought into contact the edge 163, stresses respectively concentrate on portions of the medium 10 that are respectively in contact with the multiple apexes 163P. Therefore, the medium 10 is cut in such a manner that cracks respectively progress along the first inclined portions 163A and the second inclined portions 163B starting from the portions in contact with the apexes 163P. Therefore, as compared to the cutter 16, a leading edge surface 10S is more likely to be obtained in a shorter time.

### 3. Experimental Embodiment

As an experimental embodiment of the present invention, in the above-described image forming apparatus 1 of the present embodiment, the medium 10 was cut with the cutter 16, and the leading edge surface 10S was evaluated. Here, when the angle a (FIG. 3) is varied by 5° at a time in a range from 0° to 90°, the medium 10 sandwiched by the sandwiching part 15 was cut with the edge 161. A thin sheet and a thick sheet are used as the medium 10. Evaluation results are shown in Table 1.

TABLE 1

Cutting Result

| θ | Thin Sheet | Think Sheet |
|---|---|---|
| 0° | A | A |
| 5° | A | A |
| 10° | A | A |
| 15° | A | A |
| 20° | A | A |
| 25° | A | A |
| 30° | A | A |
| 35° | A | A |
| 40° | A | A |
| 45° | A | A |
| 50° | A | A |
| 55° | A | A |
| 60° | A | B |
| 65° | B | B |
| 70° | B | C |
| 75° | C | C |
| 80° | C | C |
| 85° | C | C |
| 92° | C | C |

In Table 1, cutting results are shown in three stages of “A,” “B” and “C” in descending order of dimensional precision of the leading edge surface 10S of the cut medium 10. As shown in Table 1, when the angle α was 0° or more and 55° or less, the evaluation results were “A” for both the thin sheet and the thick sheet. When the angle α exceeded 60°, the evaluation results were “B” or “C.” Therefore, it was confirmed that, when the angle α is 0° or more and 55° or less, the cutting operation with the edge 161 can be easily and more accurately performed, and the leading edge surface 10S cut with high accuracy can be obtained.

### 4. Other Modified Embodiments

In the above, the present invention is described by illustrating the embodiment and the modified embodiments. However, the present invention is not limited to above-described embodiment and the like, and various modifications are possible. For example, in the above-described embodiment and the like, an image forming apparatus forming a color image is described. However, the present invention is not limited to this, and, for example, may be an image forming apparatus in which only a black toner image is transferred and a monochrome image is formed. Further, in the above-described embodiment and the like, a primary transfer type (direct transfer type) image forming apparatus is described. However, the present invention can also be applied to a secondary transfer type image forming apparatus.

Further, the shapes, quantities, sizes and positional relations of the components described in the above-described embodiment and the like are for illustrating an example, and the present invention is not limited to these.

Further, in the above-described embodiment and the like, the LED heads using light emitting diodes as light sources are used as exposure devices. However, for example, it is also possible to use exposure devices that use laser elements or the like as light sources.

Further, in the above-described embodiment and the like, as a specific example of the “image forming apparatus” of the present invention, an image forming apparatus having a print function is described. However, the present invention is not limited to this. That is, in addition to the print function, for example, the present invention is also applicable to an image forming apparatus that functions as a multifunction machine having a scan function and a fax function.

Further, in the above-described embodiment and the like, the medium cutting device of the present invention is provided in the medium supply part 101. However, the image forming apparatus of the present invention is not limited to this. For example, it is also possible to provide the medium cutting device of the present invention in in locking part 107.

As shown in FIG. 3, the first tangent line TL1 is determined with a sandwiching spot of the sandwiching part and a first contact spot X1 on the contact surface 17S. The sandwiching spot is a spot exactly where the medium is pinched by the sandwiching part. The first contact spot X1 is a spot of which a tangent line passes through the sandwiching spot.

The second tangent line TL2 is determined with the edge of the cutting blade and a second contact spot X2 on the contact surface 17S. The edge is a tip of the blade and exactly where the medium is cut. The second contact spot X2 is a spot of which a tangent line passes through the edge.

When defining another path length PX that is the carrying path between the edge and the second contact spot X2, a ratio (PL/PX) may be ranged from 0.5 to 2.0.

What is claimed is:

1. A medium cutting device for cutting a continuous medium carried along a carrying path in a carrying direction, comprising:
a sandwiching part that is provided on the carrying path to sandwich and carry the medium to a downstream side of the carrying direction wherein the medium is sandwiched at a sandwiching spot;
a cutting blade that is provided at the downstream side of the carrying direction from the sandwiching part, and is provided with an edge at its tip for cutting the medium sandwiched by the sandwiching part; and
a contact part that is provided at the downstream side of the carrying direction from the cutting blade, and includes a convex contact surface that is positioned on an opposite side from the sandwiching part with respect to the edge such that the carrying path runs between the contact surface and the edge, and the contact surface is configured to contact the medium when the medium is pulled toward the contact part wherein a spot on the contact surface of which a tangent line passes through the sandwiching spot is defined as a first contact spot (X1), wherein
when an imaginary straight line that connects the sandwiching spot and the first contact spot is defined as a first tangent line (TL1), at least a portion of the edge is positioned on a side at which the contact part is present with respect to the first tangent line.

2. The medium cutting device according to claim 1, wherein
the edge has a first curvature, and
the contact surface has a second curvature that is smaller than the first curvature.

3. The medium cutting device according to claim 2, wherein
the cutting blade has a convex side surface that extends from the edge toward a direction away from both the edge and the contact part.

4. The medium cutting device according to claim 3, wherein
the side surface is only a continuous surface that is formed by connecting multiple curved surfaces, each of which having different radii.

5. The medium cutting device according to claim 1, wherein
the contact surface is only a continuous surface that is formed by connecting multiple curved surfaces, each of which having different radii.

6. The medium cutting device according to claim 1, wherein
when another imaginary straight line that passes through the edge and is orthogonal to the first tangent line is defined as a second straight line (SL2),
the contact surface is positioned on an opposite side from the sandwiching part with respect to the second straight line.

7. The medium cutting device according to claim 6, wherein
another spot on the contact surface of which a tangent line passes through the edge is defined as a second contact spot (X2),
when another imaginary straight line that connects the edge and the second contact spot is defined as a second tangent line (TL2) an angle (α) formed between the second tangent line and the second straight line is ranged from 0° to 55° inclusively.

8. The medium cutting device according to claim 1, wherein
the cutting blade has a first end portion and a second end portion in a width direction of the medium, the second end portion being positioned on an opposite side from the first end portion with respect to the width direction, and
the edge is inclined at a substantially constant ratio with respect to the width direction from the first end portion to the second end portion.

9. The medium cutting device according to claim 1, wherein
the cutting blade has a first end portion and a second end portion in a width direction of the medium, the second end portion being positioned on an opposite side from the first end portion with respect to the width direction, and
the edge includes:
an apex;
a first inclined portion that is inclined so as to be more distant from the medium as the first inclined portion extends from the apex toward the first end portion;
a second inclined portion that is inclined so as to be more distant from the medium as the second inclined portion extends from the apex toward the second end portion, and
the apex intervenes between the first inclined portion and the second inclined portion on the edge.

10. The medium cutting device according to claim 1, wherein
the sandwiching part is composed with structured with a rotating body and a plate that are arranged opposing each other,
the carrying path intervenes between the rotating body and plate, and
the plate is pressed against the rotating body such that a biasing force is generated.

11. The medium cutting device according to claim 1, wherein
the sandwiching part is structured with a pair of rotating bodies,
the carrying path intervenes between the rotating bodies, and
the rotating bodies are pressed each other such that a biasing force is generated.

12. The medium cutting device according to claim 1, wherein
the cutting blade is formed of a resin.

13. The medium cutting device according to claim 1, wherein
an entire portion of the edge is positioned on the side at which the contact part is present with respect to the first tangent line.

14. The medium cutting device according to claim 1, wherein
an entire portion of the contact part is positioned on the same side at the edge with respect to the first tangent line.

15. An image forming apparatus comprising:
the medium cutting device according to claim 1.
